(19) United States
(12) Patent Application Publication
(10) Pub. No.: US 2008/0160157 A1
(43) Pub. Date: Jul. 3, 2008

(54) Method and Facility for Producing Starch-Based, Fat-Based, or Protein-Based Foodstuff or Feed Having a Defined Bulk Weight

(75) Inventors: Stefan Rutishauser, St. Gallen (CH); Markus Meyer, Egnach (CH); Konrad Munz, Schonenberg (CH)

Correspondence Address: HESLIN ROTHENBERG FARLEY & MESITI PC, 5 COLUMBIA CIRCLE, ALBANY, NY, 12203, US

(73) Assignee: BUHLER AG, Uzwil (CH)

(21) Appl. No.: 11/817,671

(22) PCT Filed: Feb. 2, 2006
(86) PCT No.: PCT/CH2006/000067

§ 371 Date: Aug. 31, 2007

(30) Foreign Application Priority Data
Mar. 3, 2005 (DE) 102005010315.4

(51) Int. Cl. A23L 1/0522; A23D 9/00; A23J 1/00; B02C 25/00; A23L 1/00

(52) U.S. Cl. 426/601; 426/661; 426/656; 99/486; 99/485

(57) ABSTRACT

The invention relates to a plant and a method for continuous production of starch-, fat- or protein-based bulk human or animal foodstuffs, or technical intermediates from a starch-, fat- or protein-based water-containing mass. The plant comprise the following sequence of regions along which the mass may be transported: a first region (2, 1, 7a), in which mechanical or thermal energy is introduced, a second region (4; 7b), in which a pressure builds up and a third region (6) to accommodate the discharged mass, whereby a forming unit (5) is arranged between the second region (4; 7b) and the third region (6). According to the invention, the plant comprises an adjustable barrier (3), between the first region (2; 1, 7a) and the second region (4; 7b) restricting the transport of the mass and a measuring device (S) is provided in the third region (6) by means of which a product parameter may be determined.

### CROSS REFERENCE TO RELATED APPLICATIONS

This application is a U.S. national stage filing under 35 USC §371 of PCT International Application PCT/CH2006/000067, filed Feb. 2, 2006, and published under PCT Article 21(2) as WO 2006/092070 on Sep. 8, 2006. PCT/CH2006/000067 claimed priority from German application 10 2005 010 315.4, filed Mar. 3, 2005. The entire contents of each of the prior applications are incorporated herein by reference.

The present invention relates to a facility and a method for the continuous production of starch-based, fat-based, or protein-based bulk foodstuffs or feeds or technical intermediate products made of a starch-based, fat-based, or protein-based compound having water according to the preamble of claim 1 or claim 30.

In the production of starch-based, fat-based, or protein-based bulk foodstuffs or feeds or technical intermediate products made of a starch-based, fat-based, or protein-based compound having water, essentially two parameters are of great significance for the product quality. These are, on one hand, the specific mechanical energy (SME) introduced into the product during the method and, on the other hand, the bulk weight or the pellet density of the produced product.

Known methods for producing the products cited at the beginning use one or more extruders for this purpose, for example. The SME is supplied to the product in the processing chamber of the extruder via rotating screw shafts by shear forces. The extruders used here typically have an intake area, a processing area, and a shaping area.

U.S. Pat. No. 5,714,187 describes a method and a facility for controlling the quality of a kneaded and compression-molded feed. The facility contains a screw press and optionally a pelleting press. The various processing areas of the facility are implemented having sensors to detect multiple product properties. Settings (setting parameters) on the devices of the facility producing the feed are changed on the basis of these detected product properties. This change of the setting parameters is either performed manually according to the principle of “trial and error” or automatically on the basis of an empirically ascertained and statistically analyzed formula. However, an isolated influence of the fill level of an extruder without changing the other process parameters is not discussed here.

DE 19714713 describes a device for treating feed having an expansion housing, which has pressure buildup and relaxation zones, as well as a material intake and inlet nozzles for water steam and a screw having differently implemented areas for pressure buildup, compression, and expansion. The device described here also has a backup element or blocking part, which encloses the screw and forms a constriction in the form of an annular gap, which prevents escape of steam via the material intake. However, a measuring device for determining product parameters and modulation of an adjustable barrier via a modulation device as a function of the product parameters is not discussed.

The SME is influenced by the following processing and system parameters (processing variables):

raw material properties (formula)

moisture (product moisture)

configuration of the extruder screws

screw speed

fill level.

The raw material properties or the formula are typically predefined and therefore basically may not be influenced.

Influencing the SME via the moisture (product moisture) is expensive, because additional water added to the product must be removed again in subsequent drying with additional energy expenditure.

Adaptation of the screw configuration is connected with reconfiguration work at least on the screw shafts and is very complex.

A change of the screw speed results in a change of the throughput. However, one typically operates at the speed maximum to achieve maximum throughput. A reduction of the speed would therefore result in throughput losses.

Therefore, only influencing the fill level remains. However, in the extruder-based methods known up to this point, influencing the fill level is not possible without a change of the other processing variables.

Adaptation and/or adjustment of the SME without having to change the other processing variables cited is therefore practically impossible.

The present invention is based on the object of allowing, in the facility cited at the beginning and/or the method cited at the beginning, adaptation or adjustment of the SME and monitoring and control of the bulk density or the density (pellet density) of the product without changing other processing variables.

This object is achieved by the facility and the method according to claim 1 or claim 30, respectively.

The facility according to the present invention has the following sequential areas, along which the compound is conveyable:
a first area having a first processing chamber, in which the compound is mixed and mechanical and/or thermal energy is introduced into the compound;
a second area having a second processing chamber, in which a pressure buildup in the compound occurs; and
a third area for receiving the compound ejected from the second area;
a reshaping unit being situated between the second area and the third area, using which the pressure-impinged compound may be reshaped into a specific shape before it is ejected into the third area.

According to the present invention, the facility has an adjustable barrier which inhibits the conveyance of the compound between the first area and the second area, and a measuring device is assigned to the third area, using which a product parameter may be determined, which is related to the bulk density and/or density of the bulk-type finished foodstuff or feed or technical intermediate product formed in the third area. According to the present invention, the measuring device is connected to a barrier activation device via a data transmission link, to adjust the adjustable barrier as a function of the product parameter which may be determined by the measuring device.

This adjustable barrier between the first area and the second area allows the fill level and thus the SME in the first area to be influenced independently of all other processing variables. Online monitoring as well as influencing the fill level and the SME during the method if necessary are even possible.

Therefore, additional freedom is obtained in the adjustment or control of the method in relation to the known typical methods and facilities, to ensure uniformly high product quality.

The measuring device is best linked with a barrier actuation device by means of a data transmission path, in order to set the adjustable barrier as a function of the product parameters determinable by the measuring device.

The data transmission path preferably has a data processing unit for processing the product parameter data received by the measuring device into control data for the barrier actuation device. It is especially advantageous for the data processing unit to be programmable, so that it can be adjusted to various measuring devices and actuation devices.

The measuring device preferably has a sampler for taking a predetermined bulk material sample volume, and filling the bulk material sample volume into a measuring cell. As a result, samples can be taken from the stream of bulk material that forms in the third zone at constant intervals, thereby enabling a quasi-continuous inspection of samples, and hence product monitoring and, if necessary, a correction of process conditions, in particular the SME.

The measuring device preferably has a scale for determining the mass of the bulk material sample volume. This makes it possible to determine the apparent density of the product as defined.

The measuring device can also exhibit a source and receiver for electromagnetic (EM) radiation, between which there is an EM radiation path that traverses the measuring cell. The weakening of introduced EM radiation of a prescribed intensity and change in its propagation rate while passing through the bulk material sample volume can also be drawn upon for indirectly determining the apparent density.

In another advantageous embodiment, the bulk material in the bulk material sample volume in the measuring cell of the measuring device can be fixed, and the measuring device has a fluid path between a fluid inlet and fluid outlet that traverses the measuring cell. Measuring the pressure drop in the fluid and throughput of the fluid as it passes through the bulk material sample volume in the measuring cell yields its fluid resistance, in particular its pneumatic resistance, which can also be drawn upon for indirectly determining the apparent density.

In another advantageous embodiment, the measuring device has a sound source and sound receiver, between which there is a sound path that traverses the measuring cell. As with the EM waves, the weakening of introduced sound waves of a prescribed intensity and change in their propagation rate while passing through the bulk material sample volume can be drawn upon for indirectly determining the apparent density.

In a particularly advantageous embodiment that enables a practically continuous monitoring of apparent density, the measuring device exhibits an impact surface arranged in or after the third zone, which extends into the bulk material stream formed in the third zone. It also has a sound receiver for recording the sound spectrum of the impact noise, and the data processing unit is provided with a spectrum analyzer for analyzing the recorded sound spectrum. The sound spectrum of the impact noise is characteristic for the apparent density (“sound fingerprint”), and can be drawn upon for monitoring the latter.

In another particularly advantageous that enables a quasi-continuous monitoring of apparent density, the measuring device contains an isolating device for isolating the bulk material particles of the bulk material stream formed in the third zone, as well as an optical imaging system for acquiring a projection surface of the respective individual bulk material particles. In this case, the data processing unit is a spectrum analyzer for analyzing the recorded projection surface spectrum.

The data processing unit preferably contains a memory for storing a setpoint for the respective product parameter corresponding to a setpoint apparent density of the bulk material, as well as a comparator for comparing an actual value for the respective product parameter acquired by the measuring device with its setpoint.

The product parameter measuring processes mentioned above are preferably executed on the bulk material samples in the measuring cell in combination, making it possible to tangibly improve the correlation between the product parameters determined in the measuring device and the bulk density of the product to be monitored.

The adjustable barrier preferably involves an adjustable cross-sectional narrowing.

The third zone can be under a pressure less or greater than the saturation vapor pressure in the water contained in the mass. This makes it possible to manufacture the products described at the outset in an expanded or non-expanded form.

In a preferred embodiment, the first zone and second zone are comprised of the processing section of a multi-screw extruder, in particular a co-rotating two-screw extruder. This embodiment is characterized by the compactness of the plant.

In another preferred embodiment, the first zone consists of the processing section of a multi-screw extruder, in particular a counter-rotating two-screw extruder, and the second zone consists of the processing section of a single-screw extruder, a counter-rotating two-screw extruder or a gear pump. This embodiment permits a strong shearing impact, and hence a high SME input into the product, on the one hand, and a strong pumping action, and hence a strong pressure buildup in the product in the second zone, on the other.

A preconditioner is best connected in series with the multi-screw extruder. The preconditioner and the multi-screw extruder then together form the first zone of the plant according to the invention. The preconditioner preferably has two serially connected chambers. The initial materials are here wetted during a relatively short retention time of the product in the first chamber, while the water can act on the initial materials for a relatively long retention time in the second chamber.

The adjustable barrier is preferably arranged inside a longitudinal section of the multi-screw extruder or two-screw extruder in a location situated between ⅕ and ⅘, in particular between ⅖ and ⅗, of the overall length of the multi-screw extruder or two-screw extruder. This ensures that enough processing space for barrier-adjustable SME product input will be provided upstream from the adjustable barrier, and that enough processing space for product pressure buildup will be provided downstream from the adjustable barrier.

The adjustable barrier can also be arranged at the downstream conveying end of the first zone formed by the multi-screw extruder or two-screw extruder, or it can be arranged at the upstream conveying end of the second zone formed by the single-screw extruder, counter-rotating two-screw extruder or gear pump. As a result, the CME can be set to a relatively high level upstream from the barrier, while a strong pumping action exists downstream from the barrier, enabling a pressure buildup over a wide pressure range.

In another preferred embodiment, the adjustable barrier consists of a respective screw-free, rotationally symmetrical section of the screw or screws of the extruder, and of at least one detent that can move relative to the respective rotationally symmetrical section and has a recess complementary to the respective rotationally symmetrical section, thereby giving rise to a gap with adjustable nip width between the respective rotationally symmetrical section and the complementary recess of the detent. The movement of the detent relative to the rotationally symmetrical section allocated thereto makes it possible to easily set the locking effect of the barrier in the extruder from outside the extruder.

In a particularly advantageous embodiment, the plant according to the invention has a pressure-setting means for setting the pressure prevailing in the mass in the second zone. The pressure-setting means can be a device for changing the quantity of water present in the mass, in particular a device for selectively supplying or removing water vapor in or out of the second zone. This makes it possible to set the pressure in the product, which is especially important when the objective is to manufacture expanded extrudates with an apparent density determined by the content of water vapor and the pressure in the product.

Interconnecting the adjustable barrier (SME control module) and pressure-setting means (density control module) in this way makes it possible to independently influence the degree of cooking based on product processing (SME) on the one hand, and the density or apparent density of the product on the other. For example, both modules can be distributed within a single extruder (co-rotating two-screw extruder), or among two different extruders (SME control module at the end of a co-rotating two-screw extruder and density control module at the beginning of a counter-rotating two-screw extruder, a single-screw extruder or a gear pump).

The pressure-setting means preferably exhibits a feed line and a discharge line for supplying or removing water vapor in or out of the second zone, wherein the feed line and the discharge line can be optionally released or blocked. Specifically blocking or releasing the respective lines hence makes it possible to set the apparent density of expanded extrudates, or to prevent the extrudates from expanding.

In a particularly preferred embodiment, the pressure-setting means encompasses a feed line, which connects the second zone with a water vapor-generating system, a first discharge line, which connects the second zone with a vacuum system, and a second discharge line, which connects the second zone with a first zone, wherein the feed line and the first and second discharge line can optionally be released or blocked. Connecting the second zone with the first zone makes it possible to return the water vapor drawn from the second zone for setting the pressure back to the first zone, for example, especially to the preconditioner. This saves on energy on the one hand, and largely prevents the emission of highly odiferous vapor into the surrounding air.

In another particularly advantageous embodiment, the measuring device contains a pressure sensor in the third zone, wherein a pressure-setting means that can be used to set the pressure in the third zone is connected to the third zone. This makes it possible to further influence the expansion behavior of the product in the third zone.

In this case, the measuring device is connected with a pressure-setting means actuation device by a data transmission path in order to set the pressure-setting means as a function of the pressure determinable by the measuring device or one of the aforementioned product parameters in the third zone.

The data transmission path here contains a data processing unit in order to process the product parameter data or pressure values from the third zone received by the measuring device into control data for the pressure-setting means actuation device.

The forming unit is best a die plate with a rotating cutting blade. This makes it possible to manufacture the products described at the outset in the form of pellets with an adjustable apparent density by expanding to more or less of an extent, or not at all, as the product exits the die plate.

The method according to the invention has the following sequential steps in consecutive zones:

a) Conveying of the mass through a first zone, which exhibits a first processing section, wherein the mass is thoroughly mixed and kneaded through exposure to mechanical and/or thermal energy, and the water acts on the mass;
b) Conveying of the mass through a second zone, which exhibits a second processing section, wherein pressure is built up in the mass;
c) reshaping the pressure-impinged compound using a reshaping unit situated between the second area and a third area;
d) ejecting the pressure-impinged and molded compound into the third area;
according to the present invention, the specific mechanical energy introduction into the compound occurring in the first area is adjusted by adjusting a barrier inhibiting the conveyance of the compound between the first area and the second area, and in the third area using a measuring device, which determines a product parameter, which is related to the bulk density and/or density of the finished foodstuff or feed or technical intermediate product. According to the present invention, the barrier is adjusted as a function of the product parameter determined in the measuring device, the actual value of the product parameter determined in the measuring device preferably being compared to a predetermined setpoint value of the product parameter and the barrier being adjusted as a function of the actual value/setpoint value deviation of the product parameter.

Preferably, a bulk product sample volume is taken from the bulk product flow in the third area repeatedly during the production of the bulk-type foodstuff or feed. At least one of the following measured variables may be determined and used as a product parameter on the basis of this bulk product sample volume, which is preferably held in a measuring cell: mass of the bulk product sample volume; attenuation of electromagnetic radiation, in particular gamma radiation, during passage through the bulk product sample volume; propagation speed of electromagnetic radiation, in particular of microwave radiation during passage through the bulk product sample volume; pressure drop of a fluid, in particular of compressed air, during passage through the fixed bulk product sample volume; attenuation of mechanical waves, in particular of sound waves, during passage through the bulk product sample volume.

The sound spectrum of the impact noise which the bulk product flow generates in or after the third area when it hits or is deflected by an impact surface may also be detected as a product parameter. To this end, use can also be made of the sound spectra of the bulk material stream as it is being deflected into a pipe elbow of a pneumatic bulk material conveying system.

To acquire another product parameter, the particles of the bulk material stream are isolated from the third zone, wherein each bulk material particle is optically acquired separately, and the projection surface spectrum of the bulk material particles is then used as the product parameter.

As already mentioned, the pressure in the third zone can also be measured. It is especially easy to correlate with the apparent density or pellet density of an expanded product.

The pressure prevailing in the mass is best set in the second zone, wherein the pressure is preferably set by supplying or removing water vapor in the second zone, so as to change the water content or product moisture of the mass.

It is particularly advantageous to optionally supply the second zone with water vapor from a water vapor generating system, or bleed water vapor from the second zone to a vacuum system, or return water vapor to the first zone from the second zone.

Additional advantages, features and possible applications of the invention may now be gleaned form the following description of exemplary embodiments based on the drawing, which are not to be construed as limiting. Shown on:

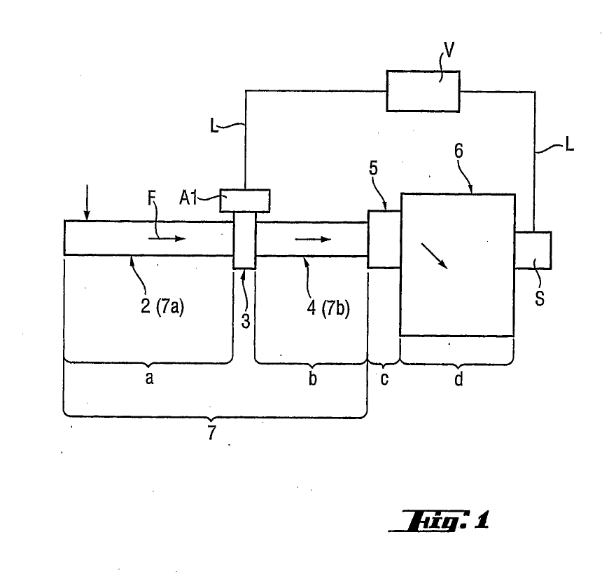

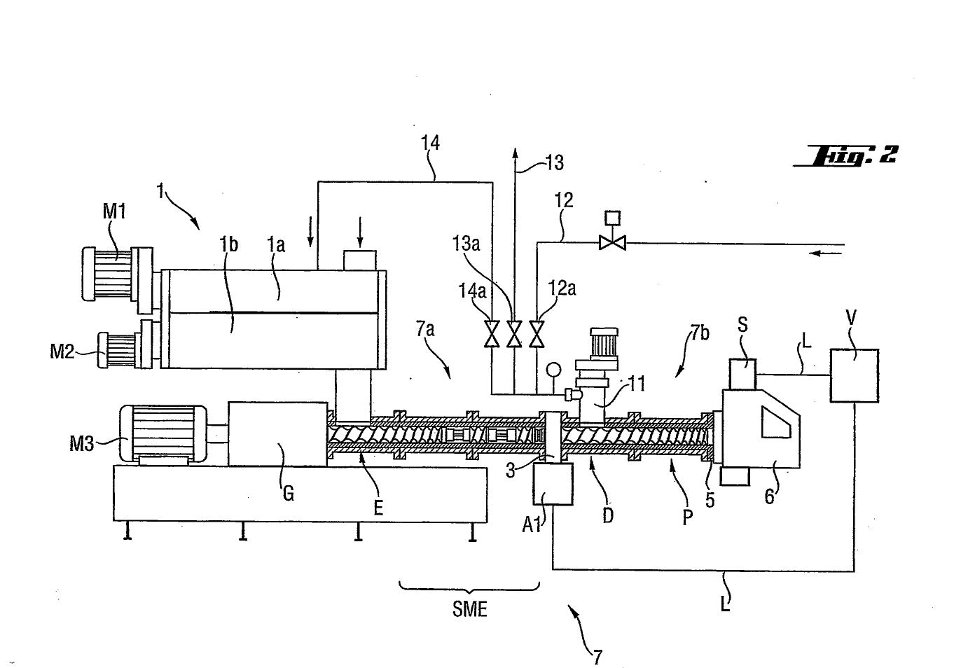

FIG. 1 is a purely diagrammatic representation of the plant according to the invention and the method according to the invention;

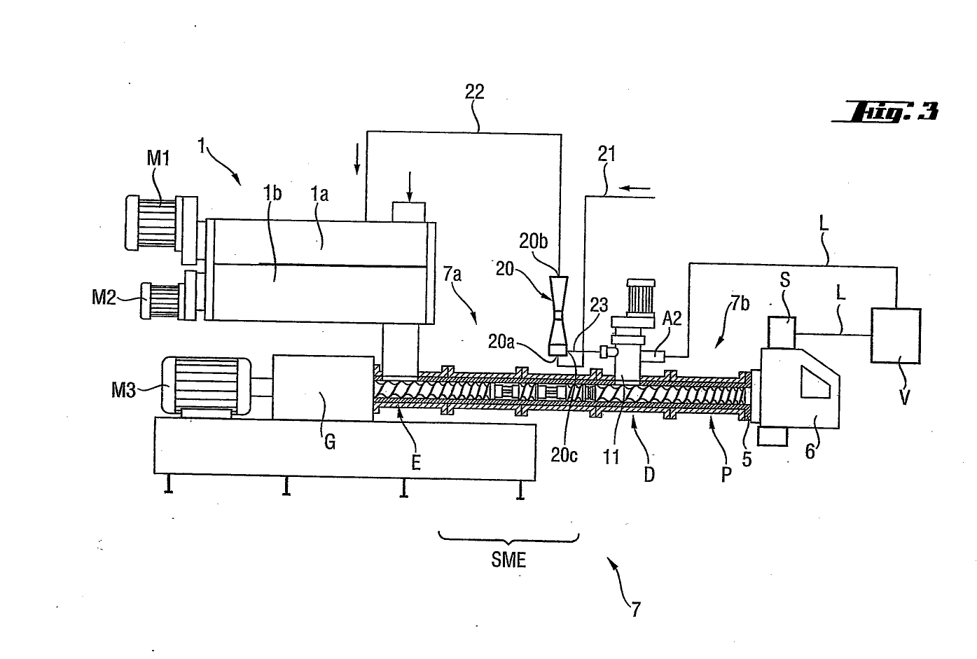

FIG. 2 is a diagrammatic, partially exploded view of a first exemplary embodiment of the plant according to the invention;

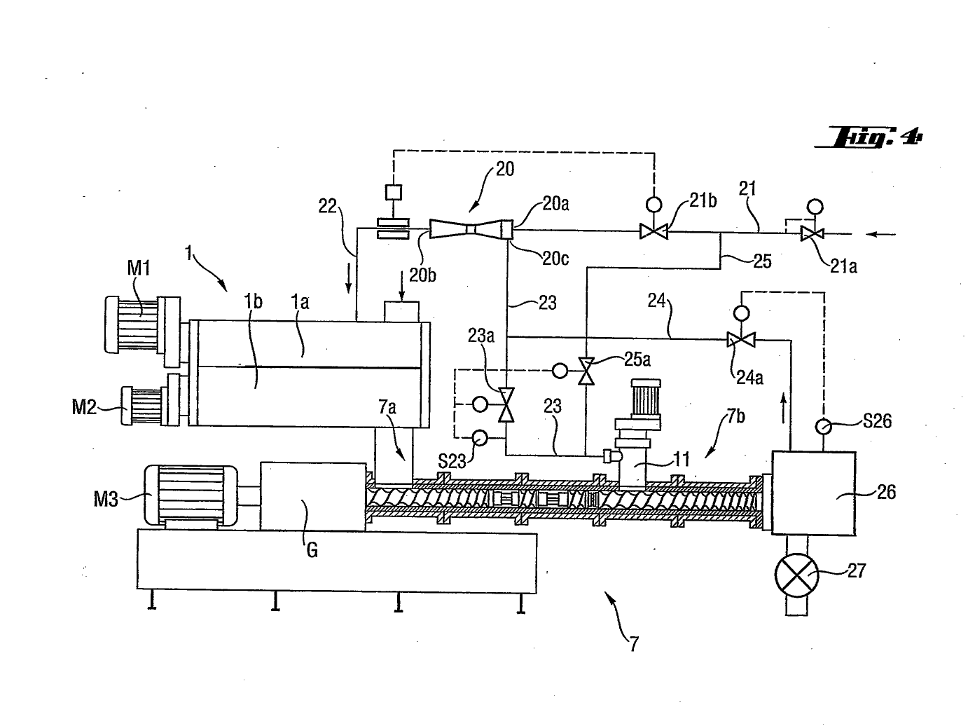

FIG. 3 is a diagrammatic, partially exploded view of a second exemplary embodiment of the plant according to the invention;

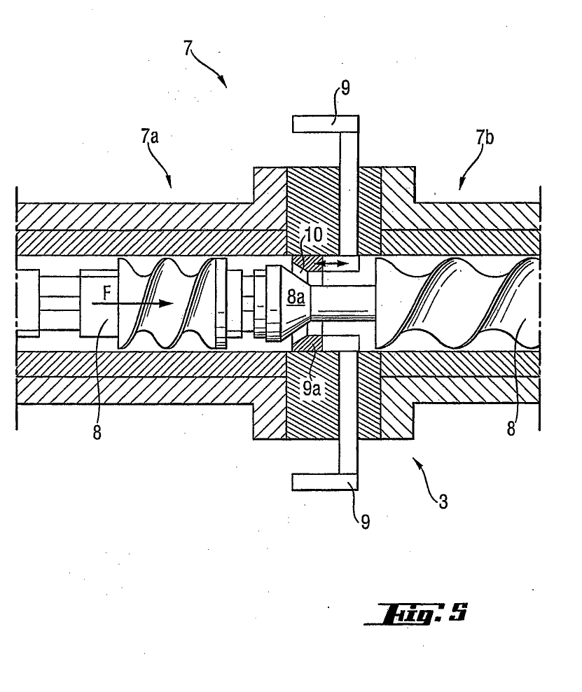

FIG. 4 is a diagrammatic, partially exploded view of a third exemplary embodiment of the plant according to the invention;

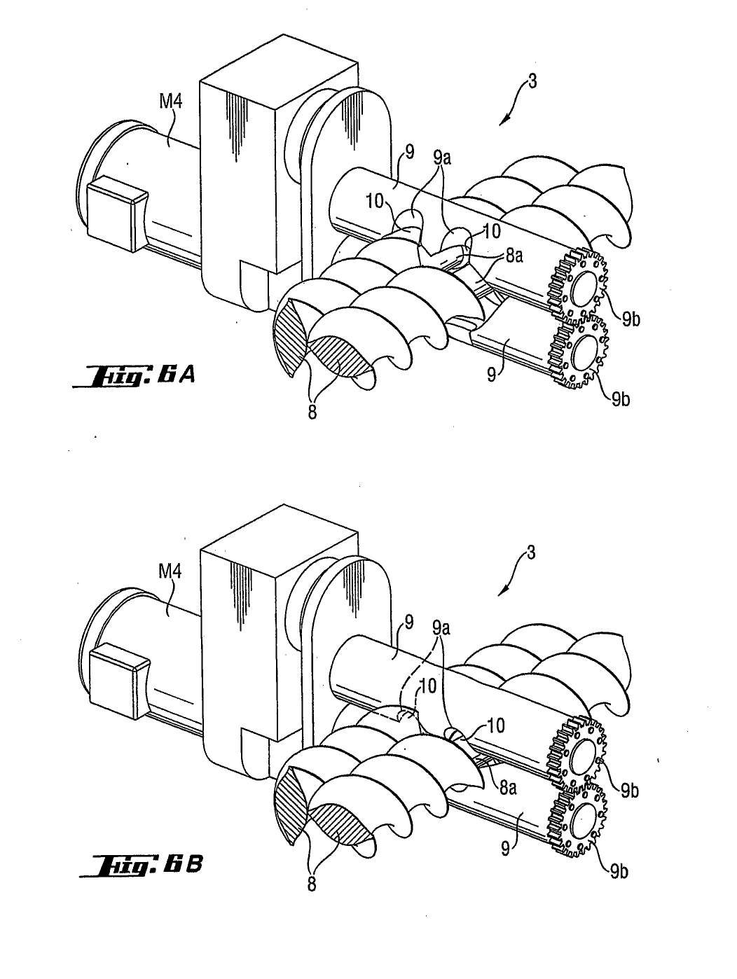

FIG. 5 is a diagrammatic, partially exploded view of a first embodiment of the adjustable barrier according to the invention; and

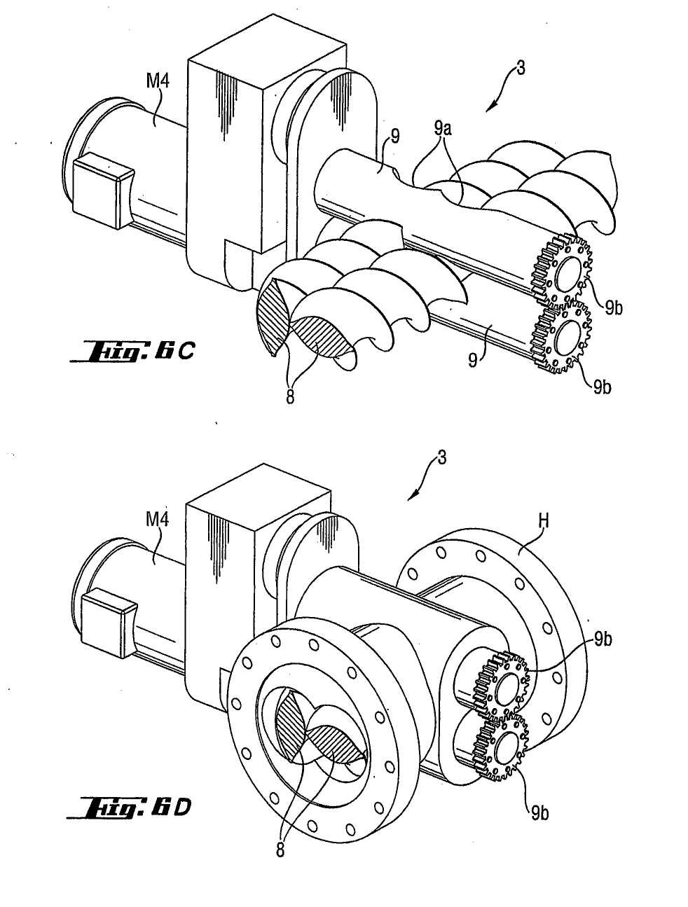

FIG. 6A, 6B, 6C, 6D are diagrammatic perspective views of a second embodiment of the adjustable barrier according to the invention in various operational settings.

FIG. 1 shows a purely diagrammatic view of the plant according to the invention, and of the method according to the invention. The arrows F denote the product flow of the mass through the plant.

The plant has the following zones along the direction of product flow:
A first zone 2, in which the mass is thoroughly mixed, and mechanical and/or thermal energy is introduced into the mass (step a);
A second zone 4, in which the pressure in the mass is built up (step b);
A third zone 6 for receiving the mass ejected from the second zone 4.

Situated between the second zone 4 and the third zone 6 is a forming unit 5, with which the pressurized mass is formed into a specific shape before ejected into the third zone 6 (step c).

Also arranged between the first zone 2 and the second zone 4 of the plant is an adjustable barrier 3 that impedes the transport of the mass, along with a product parameter-measuring device S, a data transmission path L, a measured data processing device V, and a barrier actuation device A1. The measuring device S is used to measure a product parameter for the product exiting in the third zone 6. To this end, a sampler (not shown) is used to take a bulk material sample from the bulk material stream in the third zone 6 and transfer it into a measuring chamber or measuring cell. The preferably bowl-shaped sampler can also serve as the measuring cell.

The product parameter determined in the measuring cell can be any product parameter that correlates with the apparent density or (pellet) density of the product. The following parameters are among those that can be measured:
Mass of bulk material sample volume;
Weakening of electromagnetic radiation, in particular gamma radiation, while passing through the bulk material sample volume;
Propagation rate of electromagnetic radiation, in particular of microwave radiation, while passing through the bulk material sample volume;
Pressure drop of a fluid, in particular compressed air, while passing through the fixed bulk material sample volume;
Weakening of mechanical waves, in particular sound waves, while passing through the bulk material sample volume.

The measured data obtained in the measuring device S for the respective product parameters are supplied to the measured data processing device V via the data transmission path L. There, they are processed into actuation data for the barrier actuation device A1, which are then relayed to the barrier actuation device A1 via the data transmission path L to set the barrier 3 accordingly. This influences the respectively acquired product parameter. The respective product parameter can be controlled and monitored in this way.

The reference numbers on FIG. 1 in parentheses denote the corresponding reference numbers on FIG. 2, FIG. 3 and FIG. 4.

FIG. 2 shows a diagrammatic, partially exploded view of a first exemplary embodiment of the plant according to the invention.

The plant exhibits the following sections along the direction of product flow:
A preconditioner 1 with a first chamber 1a and a second chamber 1b, in which tools (not shown) are driven by motors M1 and M2, wherein the first and second series are connected in series;
A co-rotating two-screw extruder 7 with a first partial processing section 7a and a second partial processing section 7b, between which an adjustable barrier 3 is arranged;
A forming unit 5 at the downstream conveying end of the extruder 7, e.g., in the form of a die plate and a rotating cutting blade; and
Finally, a third zone 6, which receives the completely formed product, e.g., in the form of a bulk material stream.

Along the product conveying direction, the two-screw extruder 7 driven by a motor 3 via a gearbox G exhibits a feed zone E, a cooking zone SME (SME-introduction zone), the adjustable barrier 3, a density-setting zone D and a pressure-buildup zone P. A pressure-setting means 11 is located inside the density setting zone D.

The density-setting means 11 is connected with the density-setting zone D of the extruder 7 on the one hand, and with a feed line 12, a first discharge line 13 and a second discharge line 14 on the other. The pressure-setting means can exhibit a retaining mechanism (screws conveying back into the extruder) to prevent product form exiting the extruder 7 along with aspirated vapor. A valve 12a in the feed line 12, a valve 13a in the first discharge line 13 and a valve 14a in the second discharge line 14 makes it possible to optionally supply or remove water vapor to or from the second partial processing section 7b of the extruder, wherein the removed water vapor is preferably returned to the preconditioner 1 via discharge line 14.

The following are allocated to or connected with the pressure-setting means 11:
A feed line 12, which connects the second partial processing section 7b with a water vapor-generating system (not shown);
A first discharge line 13, which connects the second partial processing section 7b with a vacuum system (not shown); and
A second discharge line 14, which connects the second partial processing section 7b with the preconditioner 1,
   wherein the feed line 12 and the first and second discharge line can be optionally released or blocked via the respective valves 12a, 13a and 14a.

The initial material (raw materials) for manufacturing the starch, fat or protein-based foodstuff or feedstuff has starch, fat or protein-containing raw materials, as well as water. These are either fed to the first zone 2 (see FIG. 1) while all already in the preconditioner 1, or gradually in the preconditioner and the first partial processing section 7a of the extruder 7.

Only a relatively small SME is introduced in the preconditioner 1, and the product is not cooked therein yet. The bulk of the SME introduction and actual cooking process only takes place in the first partial processing section 7a of the extruder 7.

The plant shown on FIG. 2 makes it possible to adjust the SME input in the extruder 7 by setting the fill level in the first partial processing section 7a of the extruder 7 via the adjustable barrier 3 on the one hand, and to adjust the density or apparent density of the product by setting the water content in the product in the second partial processing section 7b of the extruder via the pressure-setting means 11 on the other.

By comparison to conventional plants, arranging the adjustable barrier 3 between the first partial processing section 7a and the second partial processing section 7b of the extruder 7 according to the invention makes enables a decoupling of SME input adjustment and apparent density adjustment, i.e., SM input and apparent density (product density) can be set independently of each other.

As on FIG. 1, this first exemplary embodiment of the plant according to the invention has a product parameter-measuring device S, a data transmission path L, a measured data processing device V and a barrier actuation device A1.

In addition, a pressure-setting means actuation device A2 can also be hooked up to the measured data processing device S by way of a data transmission path L in this first exemplary embodiment (as in the second exemplary embodiment on FIG. 3). This is advantageous in particular when the measuring device S has a pressure sensor that acquires the atmospheric pressure in the third zone 6.

FIG. 3 presents a diagrammatic, partially exploded view of a second exemplary embodiment of the plant according to the invention. All elements identical to the corresponding elements on FIG. 2 carry the same reference number as on FIG. 2.

The plant on FIG. 3 differs from the plant on FIG. 2 in that the pressure-setting means 11 has allocated to it a vapor jet pump 20, which exhibits a vapor jet inlet 20a, a vapor jet outlet 20b and a suction inlet 20c. The vapor jet pump 20 makes it possible to generate a vacuum at its suction inlet 20c while a vapor jet passes through it from the inlet 20a to the outlet 20b. The vapor jet pump 20 in this exemplary embodiment basically comprises the pressure-setting means, since it can be used to set the vacuum applied to the density setting zone D.

In the vapor jet pump 20, the vapor jet inlet 20a is connected with a water-vapor generating system (not shown) by means of a first vapor line 21, the vapor jet outlet 20b is connected with the preconditioner 1 by means of a second vapor line 22, and the suction inlet 20c is connected with the second partial processing section 7b by means of a third vapor line 23, wherein the first, second and third vapor line 21, 22, 23 each have a first, second and third valve (not shown), with which each of them can be optionally released or blocked.

In addition a fourth vapor line (not shown) linking the first vapor line 21 and the third vapor line 23 is provided, forming a bridge line (bypass line) around the vapor jet pump 20, wherein the fourth vapor line has a fourth valve (not shown), with which it can be optionally blocked or released.

If the bride line is blocked and vapor lines 21, 22 and 23 are released, the vapor jet pump is in suction mode, and siphons water vapor from the partial processing section 7b. During subsequent expansion in the forming unit 5, this leads to an increase in the product density or apparent density.

By contrast, if the bridge line and vapor lines 21 and 23 are released, and the vapor line 22 is blocked, the vapor jet pump is in the pressure mode, and expresses water vapor introduced via the vapor line 21 out of the water vapor-generating system into the partial processing section 7b. During subsequent expansion in the forming unit 5, this leads to a decrease in the product density or apparent density.

Depending on the desired apparent density, the density of the expanded extrudates (pellets) or the expansion degree on the forming unit 5 (e.g., die plate) can be continuously adjusted within a broad range.

As on FIG. 1, this second exemplary embodiment of the plant according to the invention has a product parameter-measuring device S, a data transmission path L, a measured data processing device V, and a pressure-setting means actuation device A2.

FIG. 4 presents a diagrammatic, partially exploded view of a third exemplary embodiment of the plant according to the invention. All elements identical to the corresponding elements on FIG. 2 or FIG. 3 carry the same reference number as on FIG. 2 or FIG. 3.

The plant on FIG. 4 differs from the plant on FIG. 3 in that the suction inlet 20c of the vapor jet pump 20 is connected both with the second partial processing section 7b of the extruder (second zone 4) and the third zone 6, which is a cutting apparatus chamber 27, in which a defined pressure prevails, and which accommodates a die plate with a rotating cutting blade. The bulk material generated in the chamber 26 exits the chamber via a sluice wheel 27.

The vapor jet inlet 20a of the vapor jet pump 20 is connected with a water vapor-generating system (not shown) by means of a first vapor line 21, while the vapor jet outlet 20b of the vapor jet pump 20 is connected with the preconditioner 1 by means of a second vapor line 22. The vapor line 21 contains valves 21a and 21b, which can be controlled as required.

The vapor jet pump 20 makes it possible to generate a vacuum at its suction inlet 20c. This vacuum is supplied via a third vapor line 23 to the partial processing section 7b of the extruder (second zone 4), and relayed to the third zone 6 or the cutting apparatus chamber 26 via a fourth vapor line 24.

The third vapor line 23 has attached to it a pressure or temperature sensor S23, which actuates a valve 23a in the third vapor line.

The cutting apparatus chamber 26 has attached to it a pressure or temperature sensor S26, which actuates a valve 24a in the fourth vapor line 24.

A fifth vapor line 25 also connects the water vapor generating system (not shown) with the partial processing section 7b of the extruder. As a result, vapor can be introduced directly into the extruder 7 (direct vapor). The fifth vapor line 25 contains a valve 25a, which is also actuated by the sensor S23.

The apparent density or pellet density of the manufactured bulk material can be controlled through the interaction between the vapor lines 23, 24 and 25 with the respective valves 23a, 24a and 25a, as well as their actuation via the sensors S26 and S23.

The valves 23a and 25a can also be replaced by a three-way valve.

This arrangement makes it possible to generate a vacuum in the second zone 4 (=extruder partial zone b) and/or in the third zone 6 (=cutting apparatus chamber 26) by means of the vapor jet pump 20. This vapor jet pump is operated using process vapor from the water vapor-generating system (not shown), and permits a complete return of the thermal energy of the extruder 7 and cutting apparatus chamber 26 generated by the SME.

Exposing the third vapor line 23 at the extruder and/or the fourth vapor line 24 at the cutting apparatus chamber 26 to a vacuum, and directly supplying the vapor to the extruder 7 via the vapor line 25 makes it possible to set the apparent density or pellet density of the bulk material generated by the cutting apparatus 26. The sensors S23 and S26 in conjunction with the valves 23a and 25a or 24a they actuate enable a variation of apparent density within wide limits.

The following ranges can typically be set using this system according to the third exemplary embodiment:

Apparent density from 200 kg/m³ to 650 kg/m³

Pressure in extruder from 0.5 bar to 10 bar

Pressure in cutting apparatus from 0.5 bar to 2 bar.

As on FIG. 1, FIG. 2 and FIG. 3, this third exemplary embodiment of the plant according to the invention can additionally have an adjustable barrier 3, a product parameter measuring device S, a data transmission path L, a measured data processing device V and a barrier actuation device A1 and/or a pressure setting actuation device A2. In order to maintain clarity, these elements S, L, V and A1 and/or A2 were not shown on FIG. 4.

FIG. 5 presents a diagrammatic, partially exploded side view of a first embodiment of the adjustable barrier according to the invention.

The adjustable barrier 3 is comprised of:
A respective screw-free, rotationally symmetrical section 8a of the screw or screws 8 of the extruder 7; and
At least one detent 9 that can move relative to the respective rotationally symmetrical section 8a, with a recess 9a complementary to the respective rotationally symmetrical section 8a.

Therefore, there is a nip 10 with adjustable nip width between the respective rotationally symmetrical section 8a and the complementary recess 9a of the detent 9.

In the example shown on FIG. 5, the rotationally symmetrical section 8a and the complementary recess 9a are conical.

Axially shifting the detent 9 to the left makes the nip 10 smaller, and hence increases the fill level in the partial processing section 7a, thereby raising the introduced SME.

Axially shifting the detent 9 to the right makes the nip 10 bigger, and hence decreases the fill level in the partial processing section 7a, thereby lowering the introduced SME.

In this way, the barrier 3 that can be adjusted by changing the nip 10 makes it possible to set the SME introduced in the first partial processing section 7a independently of all remaining process variables, and in particular independently of the setting of product density or product apparent density in the second partial processing section 7b.

FIGS. 6A, 6B, 6C and 6D present diagrammatic perspective views of a second embodiment of the adjustable barrier according to the invention in various operational settings.

The SME control module 3 shown here essentially consists of two cylindrical detents 9, which are arranged one next to the other, with parallel-running cylinder axes. Each of the two detents 9 has two recesses 9a, which are complementary to a respective rotationally symmetrical section 8a of two parallel, intermeshing screws 8. The lower of the two cylindrical detents 9 is driven by a detent motor M4. At the ends facing away from the motor, each of the two detents 9 has a gear wheel 9b. The radius of the two gear wheels (spur gears) and their teeth are designed so as to intermesh. As a result, the upper detent 9 is driven by the lower detent 9 driven by the motor M4. This causes the actuated detents 9, 9 to move in opposite directions, so that the nip 10 between the rotationally symmetrical sections 8a and the complementary recesses 9a can be reduced or enlarged, depending on the rotational direction of the motor M4.

In the example shown here, the rotationally symmetrical sections 8a and the complementary recesses 9a are cylindrical.

FIG. 6A shows the SME control module 3 completely open. The two detents 9, 9 are here turned as far away from each other as possible. This setting makes it possible to disassemble the screws 8.

FIG. 6B shows the SME control module 3 swiveled by about 60°. The two detents 9, 9 are here partially turned toward each other. These and other operational settings of the detents 9, 9 make it possible to set a desired flow resistance in the module 3, and hence the fill level in the first partial processing section 7a (see FIG. 2).

FIG. 6C shows the SME control module 3 swiveled by 90°. The two detents 9, 9 are here turned as far toward each other as possible. This angular position of the detents 9, 9 enables an almost complete closure, and hence maximizes the flow resistance in the module 3, and hence the fill level in the first partial processing section 7a (see FIG. 2). In this setting, the nip 10 between the cylindrical sections 8a of the screws 8 and the complementary recesses 9a of the detents 9, 9 measures about 0.5 mm.

FIG. 6D shows the complete unit of the SME control module, including the detent casing H not shown on FIGS. 6A, 6B and 6C.

### REFERENCE NUMBERS

1 Preconditioner 8a Rotationally symmetrical section
1a First chamber 9 Detent
1b Second chamber 9a Complementary recess
2 First zone 9b Gear wheel
3 Adjustable barrier M4 Detent motor
4 Second zone H Detent casing
5 Forming unit, die plate 10 Gap
6 Third zone 11 Pressure-setting means
S Product parameter measuring 12 Feed line device 12a Valve
V Measured data processing device 13 First discharge line
L Data transmission path 13a Valve
A1 Barrier actuation device 14 Second discharge line
A2 Pressure-setting means actuation 14a Valve device 20 Pressure-setting means, vapor jet pump
7 Co-rotating multi-screw extruder 20a Vapor jet inlet or two-screw extruder 20b Vapor jet outlet
7a First partial processing section of 20c Suction inlet the MWE or ZWE 21 First vapor line
7b Second partial processing section 22 Second vapor line of the MWE or ZWE 23 Third vapor line
M1 First motor of the preconditioner 24 Fourth vapor line
M2 Second motor of the 25 Fifth vapor line preconditioner 21a Valve
M3 Extruder motor 21b Valve
F Product conveying direction 23a Valve
G Extruder gearbox 24a Valve
E Feed zone 25a Valve
SME SME introduction zone (cooking 26 Cutting apparatus chamber zone) 27 Sluice wheel
D Pressure buildup zone S23 Pressure and/or temperature sensor
S Screw S26 Pressure and/or temperature sensor

1. A facility for the continuous production of starch-based, fat-based, or protein-based bulk-type foodstuffs or feed or technical intermediate products made of a starch-based, fat-based, or protein-based compound having water, the facility having the following sequential areas, along which the compound is conveyable;
a first area (2; 1, 7a) having a first processing chamber (7a), in which the compound is mixed and mechanical and/or thermal energy is introduced into the compound;
a second area (4; 7b) having a second processing chamber (7b), in which a pressure buildup in the compound occurs; and
a third area (6) for receiving the compound ejected from the second area (4; 7b);
a reshaping unit (5) being situated between the second area (4; 7b) and the third area (6), using which the pressure-impinged compound may be reshaped into a specific form of bulk product before it is ejected into the third area (6);
characterized in that the facility has an adjustable barrier (3) which inhibits the conveyance of the compound between the first area (2; 1, 7a) and the second area (4; 7b), and a measuring device (S) is assigned to the third area (6), using which a product parameter may be determined, which is related to the bulk density and/or density of the bulk-type finished foodstuff or feed or technical intermediate product in the third area (6), the measuring device (S) being connected via a data transmission link (L) to a barrier activation device (A1), to adjust the adjustable barrier (3) as a function of the product parameter which may be determined by the measuring device (S).

2. The facility according to claim 1, characterized in that the data transmission link (L) has a data processing unit (V), to process the product parameter data received from the measuring device (S) into control data for the barrier activation device (A1).

3. The facility according to claim 1, characterized in that the measuring device (S) has a sample taker for removing a predetermined bulk product sample volume and decanting the bulk product sample volume into a measuring cell.

4. The facility according to claim 3, characterized in that the measuring device (S) has a set of scales for determining the mass of the bulk product sample volume.

5. The facility according to claim 3, characterized in that the measuring device (S) has a source and a receiver for electromagnetic radiation (EM), between which an electromagnetic radiation pathway traversing the measuring cell exists.

6. The facility according to claim 3, characterized in that the bulk product of the bulk product sample volume may be fixed in the measuring cell of the measuring device (S), and the measuring device (S) has a fluid pathway traversing the measuring cell between a fluid inlet and a fluid outlet.

7. The facility according to claim 3, characterized in that the measuring device (S) has a sound source and a sound receiver, between which a sound pathway traversing the measuring cell exists.

8. The facility according to claim 1, characterized in that the measuring device (S) has an impact surface situated in or after the third area (6), which projects into the bulk product flow formed in the third area (6), as well as a sound receiver for recording the sound spectrum of the impact noise, the data processing unit (V) containing a spectrum analyzer for analyzing the recorded sound spectrum.

9. The facility according to claim 1, characterized in that the measuring device (S) has an isolation device for isolating the bulk product particles of the bulk product flow formed in the third area (6) as well as an optical imaging system for detecting a projection area of the particular individual bulk product particles, the data processing unit (V) containing a spectrum analyzer for analyzing the recorded projection area spectrum.

10. The facility according to claim 1, characterized in that the data processing unit (V) contains a memory for storing a setpoint parameter, which corresponds to a setpoint bulk density of the bulk product, as well as a comparator for comparing a detected actual parameter of the bulk product to the setpoint parameter.

11. The facility according to claim 1, characterized in that the adjustable barrier (3) is an adjustable cross-sectional constriction.

12. The facility according to claim 1, characterized in that a pressure exists in the third area which is less than the saturation vapor pressure of the water contained in the compound.

13. The facility according to claim 1, characterized in that a pressure exists in the third area which is greater than the saturation vapor pressure of the water contained in the compound.

14. The facility according to claim 1, characterized in that the first area (2; 1, 7a) and the second area (4; 7b) are formed by the processing chamber of a multishaft extruder, in particular a synchronous dual-shaft extruder (7).

15. The facility according to claim 1, characterized in that the first area is formed by a processing chamber of a multishaft extruder, in particular of a contradirectional dual-shaft extruder, and the second area is formed by a processing chamber of a single-shaft extruder, a contradirectional dual-shaft extruder, or a gearwheel pump.

16. The facility according to claim 14, characterized in that a pre-conditioner (1) is connected upstream from the multishaft extruder (7).

17. The facility according to claim 14, characterized in that the adjustable barrier (3) is situated within a longitudinal section of the multishaft extruder or the dual-shaft extruder (7) at a location which is located between ⅕ and ⅘, in particular between ⅖ and ⅗ of the overall length of the multishaft extruder or the dual-shaft extruder (7).

18. The facility according to claim 15, characterized in that the adjustable barrier is situated at the end of the first area formed by the multishaft extruder or the dual-shaft extruder downstream from the conveyor.

19. The facility according to claim 15, characterized in that the adjustable barrier is situated at the end of the second area formed by the single-shaft extruder, the contradirectional dual-shaft extruder, or the gearwheel pump upstream from the conveyor.

20. The facility according to claim 14, characterized in that the adjustable barrier (3) is formed by a particular screw-free, rotationally-symmetrical section (8a) of the screw shaft(s) (8) of the extruder (7) and at least one blocking element (9), movable in relation to the particular rotationally-symmetrical section (8a), having an opening (9a) complementary to the particular rotationally-symmetrical section (8a), so that a gap (10) having an adjustable gap width exists between the particular rotationally-symmetrical section (8a) and the complementary opening (9a) of the blocking element (9).

21. The facility according to claim 1, characterized in that pressure adjustment means (11; 20) for adjusting the pressure existing in the compound are connected to the second area (4).

22. The facility according to claim 21, characterized in that the pressure adjustment means (11; 20) have an apparatus for changing the quantity of the water existing in the compound.

23. The facility according to claim 21, characterized in that the pressure adjustment means (11) have an apparatus (12, 13, 14) for alternately supplying or draining water steam to or from the second area (7b).

24. The facility according to claim 23, characterized in that the pressure adjustment means (11) have a supply line (12) and a drain line (13, 14) for supplying or draining water steam to or from the second area (7b), the supply line (12) and the drain line (13, 14) alternately being able to be released or blocked.

25. The facility according to claim 24, characterized in that the pressure adjustment means (11) have a supply line (12), which connects the second area (7b) to a water steam generation system, a first drain line (13), which connects the second area (7b) to a vacuum system, and a second drain line (14), which connects the second area to the first area, the supply line (12) and the first and second drain lines (13, 14) alternately being able to be released or blocked.

26. The facility according to claim 1, characterized in that the measuring device (S) has a pressure sensor in the third area (6), and pressure adjustment means (20) are connected to the third area (6) to adjust the pressure in the third area.

27. The facility according to claim 26, characterized in that the measuring device (S) is connected via a data transmission link (L) to a pressure adjustment means activation device (A2), to adjust the pressure adjustment means (20) as a function of the pressure in the third area (6), which may be determined by the measuring device (S).

28. The facility according to claim 27, characterized in that the data transmission link (L) has a data processing unit (V) to process the product parameter data received from the measuring device (S) or pressure values from the third area (6) into control data for the pressure adjustment means activation device (A2).

29. The facility according to claim 1, characterized in that the reshaping unit (5) is a nozzle plate having a rotatable blade cutter.

30. A method for the continuous production of starch-based, fat-based, or protein-based bulk-type foodstuffs or feed or technical intermediate products made of a starch-based, fat-based, or protein-based compound having water using a facility according to claim 1, the method having the following sequential steps in sequential areas:
a) conveying the compound through a first area, which has a first processing chamber, the compound being mixed and kneaded with the introduction of mechanical and/or thermal energy and the water acting on the compound;
b) conveying the compound through a second area, which has a second processing chamber, pressure being built up in the compound;
c) reshaping the pressure-impinged compound using a reshaping unit situated between the second area and a third area;
d) ejecting the pressure-impinged and molded compound into the third area in the form of a bulk product;
characterized in that the specific mechanical energy input (SME) into the compound occurring in the first area is adjusted by adjusting a barrier inhibiting the conveyance of the compound between the first area and the second area, and a product parameter is determined in the third area using a measuring device, which is related to the bulk density and/or density of the finished foodstuff or feed or technical intermediate product, the barrier being adjusted as a function of the product parameter determined in the measuring device.

31. The method according to claim 30, characterized in that the actual value of the product parameter determined in the measuring device is compared to a predetermined setpoint value of the product parameter and the barrier is adjusted as a function of the actual value/setpoint value deviation of the product parameter.

32. The method according to claim 30, characterized in that a bulk product sample volume is taken from the bulk product flow in the third area and at least one of the following measured variables is determined and used as a product parameter:
(i) mass of the bulk product sample volume;
(ii) attenuation of electromagnetic radiation, in particular of gamma radiation, during passage through the bulk product sample volume;
(iii) propagation speed of electromagnetic radiation, in particular of microwave radiation, during passage through the bulk product sample volume;
(iv) pressure drop of a fluid, in particular compressed air, during passage through the fixed bulk product sample volume; and
(v) attenuation of mechanical waves, in particular of sound waves, during passage through the bulk product sample volume.

33. The method according to claim 30, characterized in that the sound spectrum of the impact noise which the bulk product flow generates in or after the third area when it hits or is deflected by an impact surface is detected as a product parameter.

34. The method according to claim 30, characterized in that the particles of the bulk product flow from the third area are isolated and each bulk product particle is separately detected optically and the projection area spectrum is used as a product parameter.

35. The method according to claim 30, characterized in that the pressure in the third area is measured.

36. The method according to claim 30, characterized in that a pressure exists in the third area which is less than the saturation vapor pressure of the water contained in the compound, so that the molded compound under pressure expands upon its entry into the third area.

37. The method according to claim 30, characterized in that a pressure exists in the third area which is greater than the saturation vapor pressure of the water contained in the compound, so that the molded compound under pressure does not expand upon its entry into the third area.

38. The method according to claim 30, characterized in that the pressure existing in the compound is adjusted in the second area.

39. The method according to claim 36, characterized in that the pressure is adjusted by supplying or draining water steam to or from the second area to change the water content or the product moisture of the compound.

40. The method according to claim 39, characterized in that alternately water steam is supplied by a water steam generating system to the second area or water steam is withdrawn to a vacuum system from the second area or water steam is returned to the first area from the second area.
